(19) United States
(12) Patent Application Publication
(10) Pub. No.: US 2004/0012116 A1
(43) Pub. Date: Jan. 22, 2004

(54) Method for melting a polymer granulate and melt element

(76) Inventors: Theodor Jurgens, Castrop-Rauxel (DE); Rudolf Geier, Essen (DE)

Correspondence Address: CARELLA, BYRNE, BAIN, GILFILLAN, CECCHI,, STEWART & OLSTEIN, 6 BECKER FARM ROAD, ROSELAND, NJ, 07068, US

(21) Appl. No.: 10/363,459

(22) PCT Filed: Aug. 28, 2001
(86) PCT No.: PCT/EP01/09876

(30) Foreign Application Priority Data
Aug. 29, 2000 (DE) 10042478.3

(51) Int. Cl. B29C 47/00

(52) U.S. Cl. 264/211.22; 425/72.2; 425/378.2

(57) ABSTRACT

The invention relates to a method for melting a polymer granulate on a melt element to enable the melted granulates to be spun. In order to allow the granulate to melt in an energetically viable manner, without high thermal or mechanical strain, a melt element which is conically tapered towards the openings on the underside of said melt element is used. The spherical particles thereof are introduced into said openings in the form of a granulate with an average diameter of D₃, having a ratio to the entrance-side diameter D₁ of the opening of 2*D₃≧D₁≧D₃.

The invention relates to a procedure for melting polymer granules on a grate-shaped melting element and subsequently spinning the melted granules. In addition, the invention relates to a grate shaped melting element for melting granules, in particular polymer granules, preferably meant for melt spinning. Finally, the invention is aimed at a device for melt spinning.

During melt spinning, macromolecular raw material is melted and spun, wherein the fibers are solidified through cooling. Essentially two different melt spinning procedures are known from practice, specifically reprocessing the raw material with fusible grates or via extruders, wherein the raw material is always present as granules. In the first mentioned procedure, the cylindrical granules exit a storage tank and get onto the fusible grate under a nitrogen atmosphere. This fusible grate can consist of adjacent tubes that are heated. The melt drips from the grate into a sump, from which the melt is conveyed via pumping to spinnerets.

This process of melting by means of fusible grates, which are also referred to as grate spinnerets, came into use in particular in the period between 1940 and the 50's. For reasons of economic efficiency and to attain higher melting capacity, i.e., to achieve higher throughputs at spinning mills, extruders were then used for fiber manufacture. Due to higher melting efficiencies and system throughputs, this so-called extruder spinning has become popular in particular for medium-viscous melts with an intrinsic viscosity ranging between 0.6 and 0.7.

Known from DD 44 624 A is a device for melt-spinning molded bodies according to the grate spinning process. A melting body intended for melting chip-shaped high polymers has boreholes shaped like a funnel on the feed side.

In order to melt organic compounds for manufacturing yarn, GB 719,062 proposes a plate consisting of silver with numerous boreholes expanded on the inlet side in the shape of a funnel.

In recent years, increasingly stringent requirements have been placed on the quality of technical yarns. This is to be accompanied simultaneously by cost-effective production. However, significant damage can arise during the treatment of granules, e.g.:

Hydrolytic damage: if too much moisture adheres to the granules, the viscosity is reduced while melting, which diminishes the strength. This damage can be avoided by drying the granules to a residual moisture of 12 ppm;

Oxidative damage: while melting the granules, the presence of oxygen results in an oxidation, and hence in a reduction in strength. This can be remedied having melting take place in an inert gas atmosphere, in particular an N₂ atmosphere;

Mechanical damage: using extruders to melt the granules gives rise to shear stresses that shorten or break molecule chains;

Thermal damage: given excessive retention times of the melted granules, e.g., due to transport in pipes to spinnerets, a decrease in viscosity sets in, resulting in a reduction in strength.

These lengthy retention times are necessitated by more complex melt distribution systems, and the resultant, increasingly long retention times. For this reason, ever-increasing numbers of static mixers must be incorporated into more complex distribution systems to prevent the melt from becoming separated during a laminar flow. However, corresponding mixers result in significant pressure losses, which in turn can be compensated by higher extruder driving powers and frictions.

The object of this invention is to further develop a procedure or melting element of the kind mentioned at the outset in such a way as to largely avoid mechanical and thermal damages to the melted granules, so that the quality of the yarns to be fabricated can be improved. The object is achieved according to the invention in a procedure for melting polymer granules with a grate-shaped melting element by having the melting element be one having openings that conically narrow toward the bottom side of the melting element, to which spherical particles are supplied as granules with an average diameter D₃ that behaves as follows relative to the inlet side diameter D₁ of the opening: 2*D₃≧D₁≧D₃.

According to the invention, spherical particles are used as granules, which in particular have a residual moisture of ≦20 ppm, preferably ≦10 ppm, and a diameter of between 0.5 and 2 mm. The intrinsic viscosity should like between 0.75 and 1.3. Using spherical granules enables an optimal heat transfer, and hence melting of granules, in the nozzle-shaped openings that narrow toward the bottom side and have the geometry of a truncated cone, without having to set the melting element to temperatures significantly exceeding the melting temperature of the granules themselves. At the same time, the time for which the spherical granules are in contact with the melting element is reduced. The danger of thermal damage is minimized as a result. Mechanical damage can also not occur, since no shearing forces are at work during melting.

In other words, the granules melt in a very short time regardless of their low thermal conductivity, wherein the invention is developed further by having a heat transfer to spherical particles with an initial volume VA take place within the opening of the melting element in such a way that its unmelted residual volume V_{R} measures roughly 0.02 V_{A} or less than 0.02 V_{A} when exiting the opening. The residual solid left behind in this way is then melted in the melt sump present below the melting element.

The melting element should be set to a temperature T₁ that exceeds the melting temperature of the granules by roughly 5° C. to 20° C., in particular 5° C. to 10° C. This ensures that thermal damages will be largely precluded.

A melting element for melting granules, in particular polymer granules, preferably intended for melt spinning, is characterized in that the plate-shaped melting element has openings that narrow toward its bottom side, having a diameter D₁ at the inlet side and a diameter D₂ at the outlet side with 4*D₂≧D₁≧6*D₂, wherein D₁≧2*D₃ with D₃ being the average diameter of spherical particles supplied to the melting element as the granules.

The melting element itself can be set to a temperature T₁ exceeding the melting temperature T₂ of the granules by roughly 5° C. to 20° C. In addition, the nozzle-shaped openings are to have a height h measuring roughly 1 to 3 times the inlet diameter D₁.

In addition, the invention is characterized by an arrangement for melt spinning polymer granules with a storage container for holding the granules and at least one spinning location linked with the storage container by means of a first conveying aggregate, wherein the spinning location comprises a casing pressurized with inert gas, whose top side has a metering device to which the granules can be supplied, a plate or grate-shaped melting element situated in the casing with truncated cone-shaped openings that narrow toward its bottom side, a sump area located in the floor-side casing to receive melted granules, a second conveying device downstream from the sump area for supplying the melt to spinnerets, wherein the melting element is set in particular to a temperature T₁ that exceeds the melting temperature T₂ of the granules by roughly 5° C. to 20° C.

In this case, the second conveying device preferably consists of two series-connected toothed wheel-metering pumps, which can each be operated at a constant, yet variable speed. The casing-side toothed wheel-metering pump can here be operated at speed N₁, and the downstream toothed-wheel-metering pump can be operated at a speed of N₂, with N₁<N₂.

The metering device can be controlled as a function of the fill level of the melt sump. This can take place via nitrogen pearl level measurements or mechanical and/or electromechanical fill level devices. A mechanical or pneumatic drive can be used to activate the metering device, like a metering valve.

The first conveying device leading from the storage tank to the spinning location can be a vibration conveyor pressurized with nitrogen.

Additional details, advantages and features of the invention are contained not only in the claims, the features to be gleaned from them, whether separately and/or in combination, but also in the following description of a preferred exemplary embodiment as shown on the drawings.

Shown on:

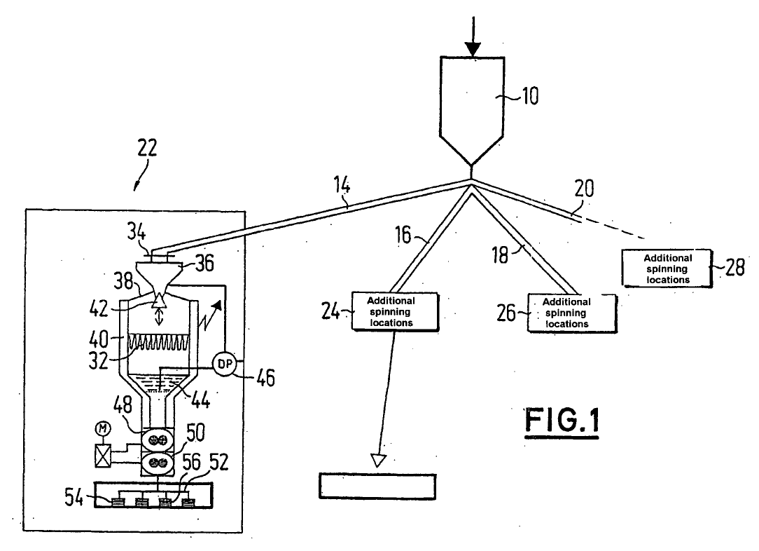

FIG. 1 is a basic view of a device for melting granules;

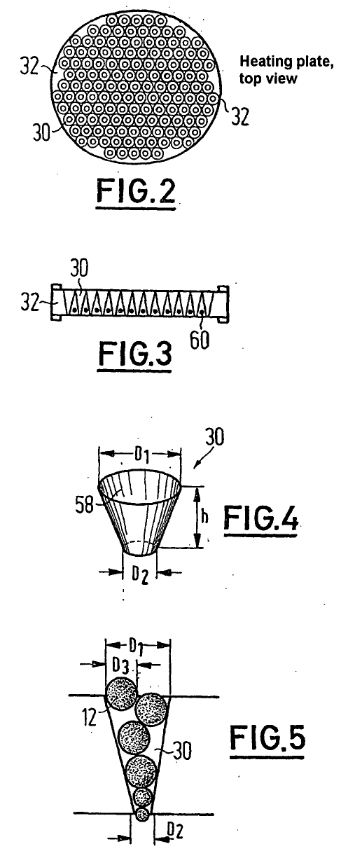

FIG. 2 is a top view of a melting element;

FIG. 3 is a cross section through the melting element according to FIG. 2;

FIG. 4 is a perspective view of an opening in the melting element according to FIG. 2; and

FIG. 5 is a basic view of an opening in the melting element according to FIG. 2 with granules melting therein.

In order to largely eliminate mechanical and thermal damage while melting and spinning macromolecular raw materials, spherical polymer granule particles, so-called pellets 12, are conveyed from a storage tank 10 via first conveying devices 14, 16, 18, 20 to spinning locations 22, 24, 26, 28.

The pellets 12 here in particular have a residual moisture of especially less than 12 ppm, preferably less than 5 ppm, and a diameter ranging between 0.5 mm and 2 mm, wherein the average diameter depends on the dimensioning of openings 30 in a plate-shaped melting element 32 to be described in greater detail below, which in the following is referred to as a melting grate or only as a grate for purposes of simplification.

Conveying devices 14, 16, 18, 20 preferably involve vibration-conveying grooves pressurized with nitrogen.

Since spinning locations 22, 24, 26, 28 have essentially the same structure, spinning location 22 will be described in greater detail. The pellets 12 travel from the vibration conveying groove 14 leasing to the spinning location and arrive at a funnel 36, which can be locked by means of a slider 34, and is arranged in the top area 38 of a casing 40 pressurized with nitrogen or another inert gas. The funnel 36 can be sealed on the casing side with a metering valve 42, so that it can meter pellets into the casing 40 to melt the latter in the way described below.

Extending over the cross section of the casing 40 is the plate-shaped melting grate 32 used to melt the pellets 12 and then drip them into a melting sump 44 in the floor area of the casing 38. The metering valve 42 is controlled as a function of the amount of melt accumulated in the melting sump 44. In this case, the metering valve 40 can be operated and controlled using known methods or measuring devices, i.e., directly and mechanically via level meters arranged in the melting sump 44. As an alternative, a differential pressure 46 of the sump level can be ascertained by means of a so-called pearl level measurement with nitrogen. The metering valve 12 can itself be opened or closed via a pneumatic drive in the required scope, for example.

The melt is conveyed to a desired number of spinnerets 54, 56 from the melting sump 44 by means of two series-connected toothed wheel-metering pumps 48, 50 as conveying aggregates via short distribution lines 52, and hence at short retention times.

The melting grate 32 has openings 30 that conically narrow toward the bottom side, which have a truncated cone geometry and an inlet diameter D₁ and outlet diameter D₂. In this case, the diameter D₁ is at most two times the diameter D₃ of the unmelted pellets, while the outlet diameter D₂ measures roughly 0.25 to 0.15 of the diameter D₃. As a result, the melted pellets 12 do not impede each other while passing through the opening 30. Rather, there is a good thermal contact between the pellets 12 and inner wall 58 of the opening 30, so that, despite their poor thermal conductivity, the pellets 12 melt to a sufficient extent and relatively quickly, without the melting grate 32 having to be heated to an undesirably high level. The grate can instead be set to a temperature T₁ exceeding the melting temperature T₂ of the pellets 12 by about 5° C. to 20° C.

When using PET (polyethyleneterephthalate) balls as pellets 12, which have a melting temperature of approx. 265° C., it is sufficient for the melting grate 32 to be heated to a temperature 270° C. to 280° C. This can be done by means of heating coils 60 running between the openings 30.

The height of the opening 30 itself should measure roughly 3 to 5 times the diameter D₃ of the pellets 12 to be melted.

The instruction according to the invention yields a small temperature gradient between the pellets 12 and contact surface 58 of the openings 30, i.e., the melting grate 32, since the largest heating surface is available at the lowest volumes. This largely precludes a negative thermal load on the pellets 12. Due to the minimal retention time of the pellets 12 passing through the opening 30, use for highly viscous products is particularly suited.

The retention time in the sump is also minimized, wherein an optimal adjustment between the pellets supplied via the metering valve 42 and the melt withdrawn via the conveying device, e.g., the toothed wheel-metering pumps 48, 50, is enabled by monitoring the sump level, in particular via pearl level measurement.

1. A procedure for melting polymer granules on a grate-shaped melting element for subsequently spinning the melted granules, characterized in that the melting element is one having openings that conically narrow toward the bottom side, to which spherical particles are supplied as granules with an average diameter D₃ that behaves as follows relative to the inlet side diameter D₁ of the opening: 2*D₃≧D₁≧D₃.

2. The procedure according to claim 1, characterized in that the melting element is set to a temperature T₁ that exceeds the melting temperature T₂ of the spherical particle by roughly 5° C. to 20° C., in particular 5° C. to 10° C.

3. The procedure according to claim 1 or 2, characterized in that a heat transfer to the spherical particle with an initial volume V_{A} takes place within the opening of the melting element in such a way that its unmelted residual volume V_{R} measures roughly 0.02 V_{A} or less than 0.02 V_{A} after exiting the opening.

4. The procedure according to at least one of the aforementioned claims, characterized in that the granules used have a residual moisture of ≦20 ppm, in particular ≦10 ppm.

5. The procedure according to at least one of the aforementioned claims, characterized in that spherical particles with a diameter of between 0.5 mm and 2.0 mm are used as the granules.

6. The procedure according to at least one of the aforementioned claims, characterized in that granules with an intrinsic viscosity of between 0.75 and 1.3 are used.

7. A melting element (32) for melting granules (12), in particular polymer granules, preferably intended for melt spinning, characterized in that the grate-shaped melting element (32) has openings (30) that narrow toward its bottom side.

8. The melting element according to claim 7, characterized in that the melting element (32) can be set to a temperature T₁ exceeding the melting temperature T₂ of the granules (12) by about 5° C. to 20° C.

9. The melting element according to claim 7 or 8, characterized in that the conically tapering opening (30) of the plate-shaped melting element (32) with the geometry of a truncated cone has an inlet diameter D₁ and an outlet diameter D₂ with 4*D₂≦D₁≦6*D₂ and 2*D₃≧D₁≧D₃, wherein D₃ is the average diameter of spherical particles (12) supplied to the melting element as the granules.

10. The melting element according to one of claims 7 to 9, characterized in that the nozzle-shaped openings (30) have a height of roughly 1 to 5 times the inlet diameter D₁.

11. A device for melt spinning polymer granules, with a storage tank (10) for holding the granules, at least one spinning location (22, 24, 26, 28) linked with the storage container by means of a first conveying aggregate (14, 16, 18, 20) with a casing (40) pressurized with inert gas, whose top side has a metering device (42) to which the granules can be supplied, a plate or grate-shaped melting element (32) situated in the casing with truncated cone-shaped openings (30) that narrow toward its bottom side, a sump area (44) located in the floor-side casing to receive melted granules, a second conveying device (48, 50) downstream from the sump area for supplying the melt to spinnerets (54, 56).

12. The device according to claim 11, characterized in that the melting element (32) is set to a temperature T₁ exceeding the melting point T₂ Of the granules by about 5° C. to 20° C.

13. The device according to one of claims 11 or 12, characterized in that the second conveying device comprises two series connected toothed wheel-metering pumps (48, 50) that each can be operated at constant, but variable speeds (N₁, N₂).

14. The device according to claim 11 to 13, characterized in that the toothed wheel-metering pump (48) arranged on the casing side can be operated at a speed of N₁, and the downstream toothed wheel-metering pump can be operated at a speed of N₂, wherein N₁<N₂.

15. The device according to one of claims 11 to 14, characterized in that the metering device (42) that supplies the granules to the casing can be controlled via the melt accumulated in the melt sump (44).
